(19) United States
(12) Patent Application Publication
(10) Pub. No.: US 2019/0329466 A1
(43) Pub. Date: Oct. 31, 2019

(54) METHOD OF MAKING A HYBRID BEAM AND HYBRID BEAM

(71) Applicants: Gari SCHALTE, Rochester Hills, MI (US); Magna Exteriors Inc., Concord (CA)

(72) Inventors: Steven Grgac, Mississauga (CA); Gari Schalte, Rochester Hills, MI (US); Philip Grella, Newmarket (CA)

(73) Assignee: Magna Exteriors Inc., Concord, ON (CA)

(21) Appl. No.: 16/467,854

(22) PCT Filed: Dec. 8, 2017
(86) PCT No.: PCT/US17/65242

§ 371 Date: Jun. 7, 2019

Related U.S. Application Data
(60) Provisional application No. 62/431,842, filed on Dec. 9, 2016.
(60) Provisional application No. 62/516,732, filed on Jun. 8, 2017.

(51) Int. Cl. B29C 45/14

(52) U.S. Cl. CPC B29C 45/14311; B29C 45/14631; B29L 2031/3002; B29C 2045/14885; B29C 2045/14868

(57) ABSTRACT

Reinforced composite structural members and methods of forming thereof. The method includes providing one or more reinforcements, one or more adhesives, a mold with a mold cavity and resin. The one or more reinforcements are coated with the one or more adhesives and then are placed within the mold cavity. Next the mold cavity is closed and a step of overmolding the one or more reinforcements by injecting molten resin into the mold cavity, then curing the molten resin to form the structural member. The one or more adhesives coated onto the one or more reinforcements facilitates the bonding of the resin of material to the one or more reinforcements.

### CROSS-REFERENCE TO RELATED APPLICATIONS

This application is a PCT International Application of U.S. Provisional Application No. 62/431,842 filed on Dec. 9, 2016. This application is also a PCT International Application of U.S. Provisional Application No. 62/516,732 filed on Jun. 8, 2017. The disclosure(s) of the above application(s) is (are) incorporated herein by reference.

### TECHNICAL FIELD

The present invention relates to a method of creating a vehicle structural member using reinforcement rods, adhesives and overmolding.

### BACKGROUND OF THE INVENTION

In the automotive field there has been an increasing number of vehicle structural members being formed of composite materials. These composite materials reduce the production time and vehicle weight, allow for more complex shapes and many times reduces cost when compared to traditional metal fabricated structural members. One of the issues, particularly with structural members is strength provided by the composite structural member. Structural members often are required to be able to withstand certain forces. Composite structural members often times the components can shatter into several small and larger fragments upon impact, therefore it is desirable to develop structural members that can withstand a high degree of force and minimize the shattering effect.

### SUMMARY OF THE INVENTION

The present invention is directed to reinforced composite structural members and methods of forming reinforced composite structural members. One exemplary embodiment is directed to a reinforced composite front end module for a vehicle. The method includes providing one or more reinforcements, one or more adhesives, a mold with a mold cavity and resin. The one or more reinforcements are coated with the one or more adhesives and then are placed within the mold cavity. Next the mold cavity is closed and a step of overmolding the one or more reinforcements by injecting molten resin into the mold cavity, then curing the molten resin to form the structural member. The one or more adhesives coated onto the one or more reinforcements facilitates the bonding of the resin of material to the one or more reinforcements.

The present invention is also directed to different types of structural members. One particular structural member is a reinforced composite front end module for a vehicle. The reinforced composite front end module includes a one piece composite body formed of polymer resin material reinforced with fiber fillers. One or more openings are formed in the body and have a plurality of attachment points for additional structures such as louvers or vanes that can be connected to and extend across the one or more openings. Also formed in the body is an integrally formed active grille shutter system motor housing for receiving a motor for controlling the movement of the louvers once they are connected. Also provided is a plurality of coated reinforcements that are overmolded onto the body, wherein the coated reinforcements are coated with a layer of one or more adhesives that hold the resin of the one piece composite body to the respective one of the plurality of coated reinforcements.

### BRIEF DESCRIPTION OF THE DRAWINGS

The invention will be described below with reference to exemplary embodiments illustrated in the drawing, wherein:

FIG. 1A schematically depicts a method of creating a structural member using adhesives according to one embodiment of the invention.

FIG. 1B schematically depicts a method of creating a structural member using adhesives according to one embodiment of the invention.

FIG. 1C schematically depicts a method of creating a structural member using adhesives according to one embodiment of the invention.

FIG. 1D shows a front perspective view of a front end module formed in accordance with the embodiment of the invention shown in FIGS. 1A-1C.

FIG. 1E shows a rear perspective view of a front end module formed in accordance with the embodiment of the invention shown in FIGS. 1A-1C.

FIG. 2A schematically depicts a method of creating a structural member using adhesives according to a second embodiment of the invention.

FIG. 2B schematically depicts a method of creating a structural member using adhesives according to the second embodiment of the invention.

FIG. 20 shows a front perspective view of a front end module formed in accordance with the embodiment of the invention shown in FIGS. 2A-2B.

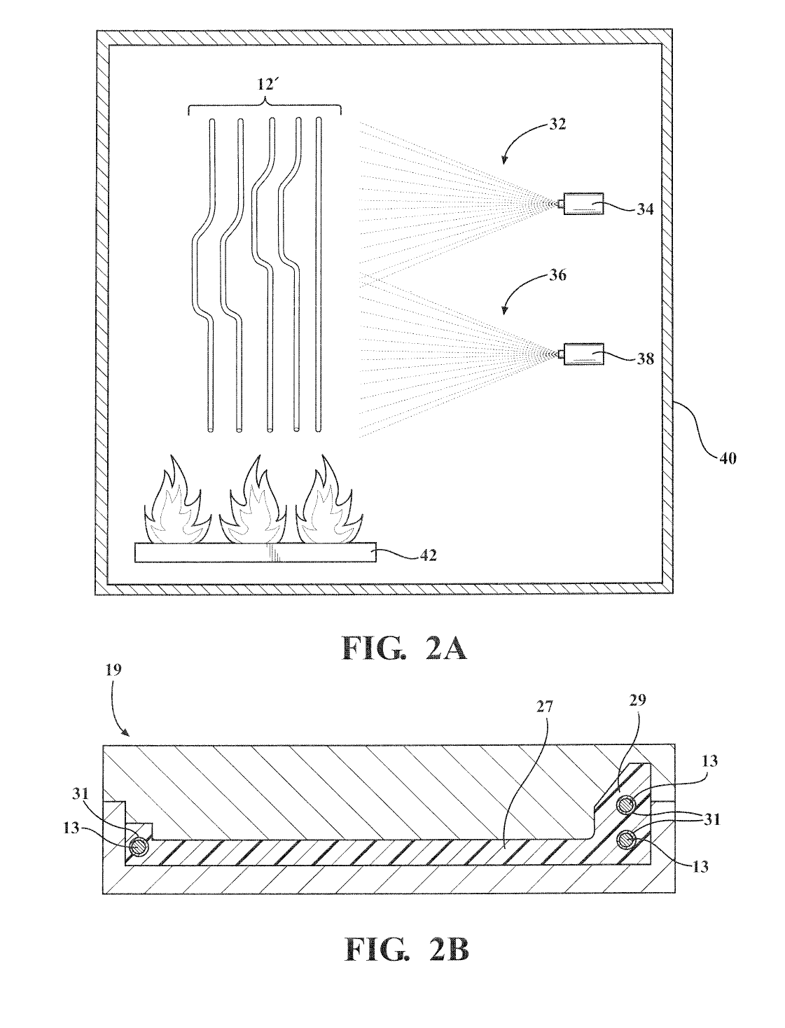

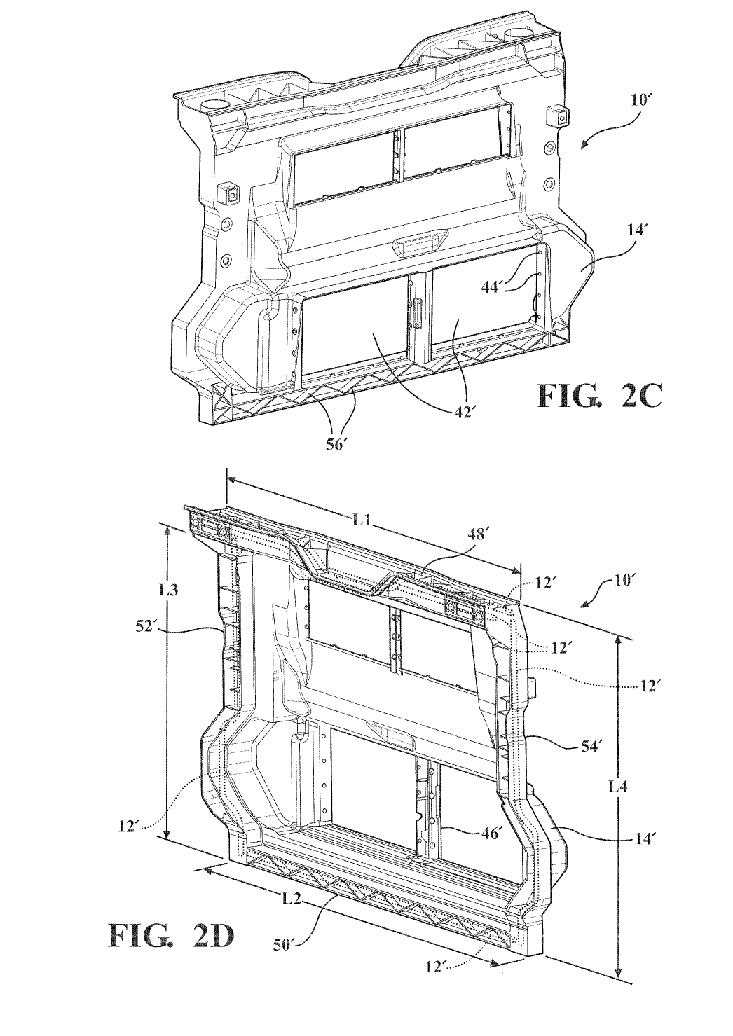

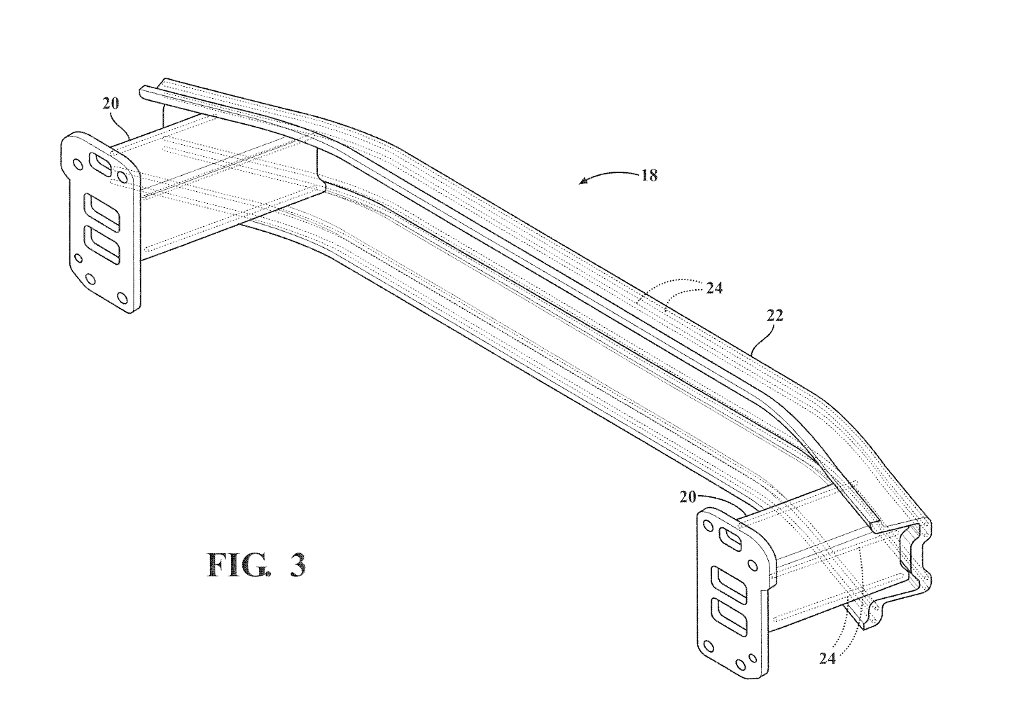

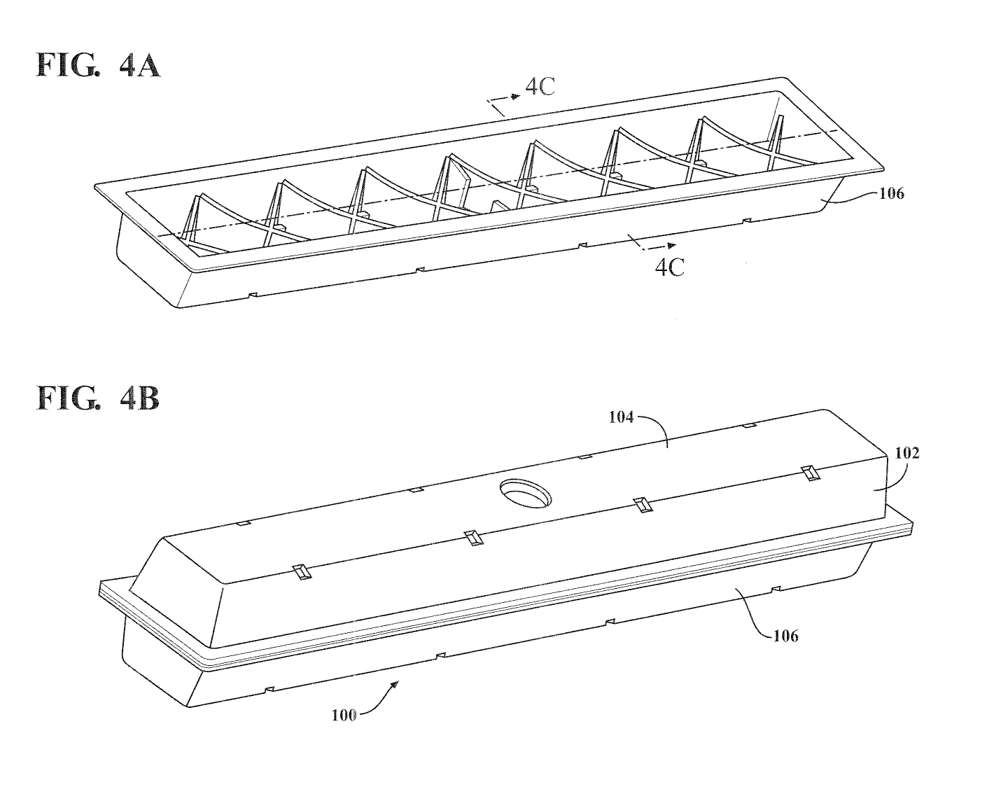

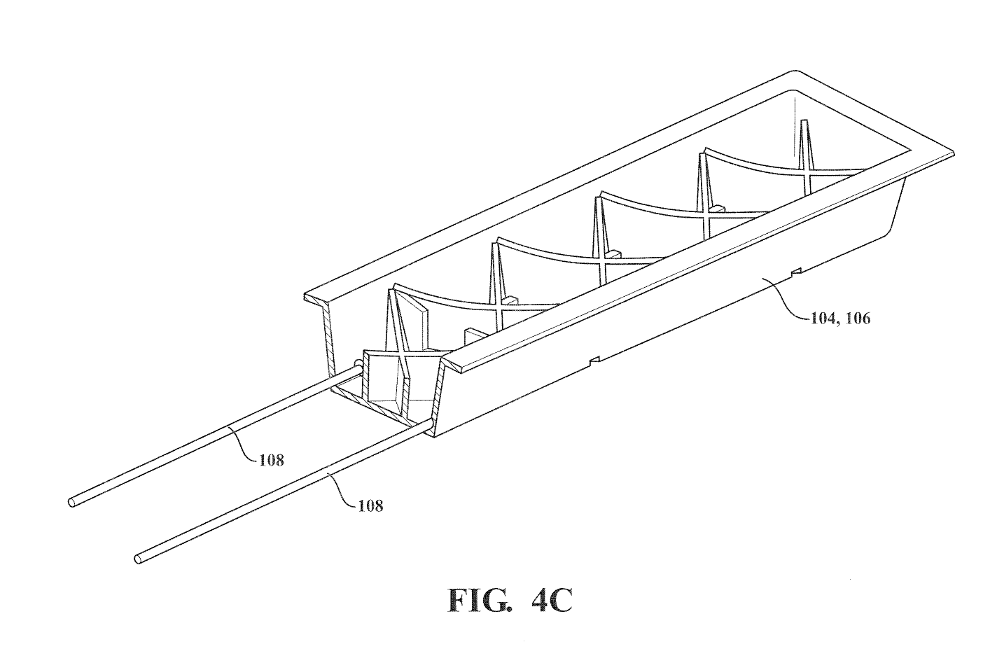

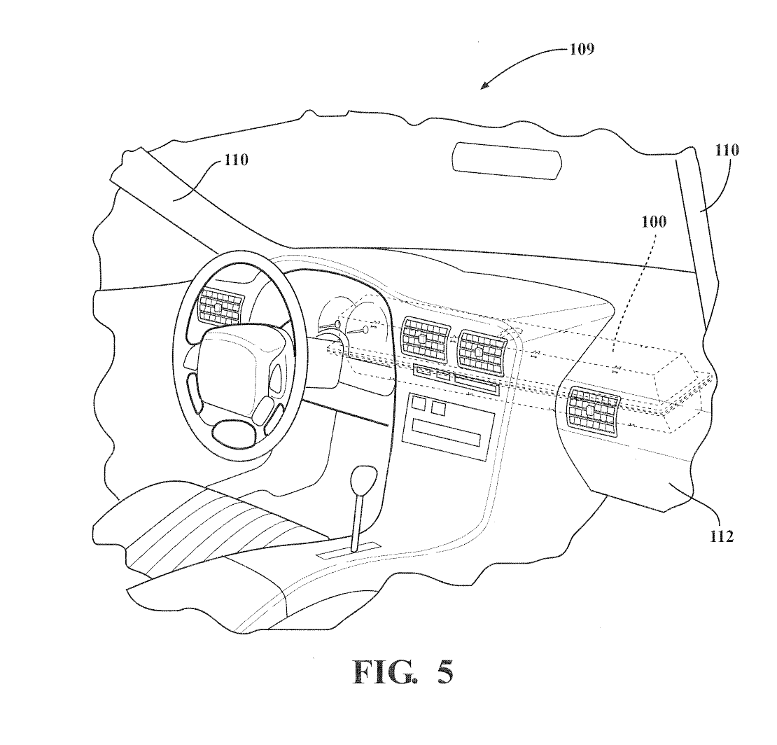

FIG. 2D shows a front perspective view of a front end module formed in accordance with the embodiment of the invention shown in FIGS. 2A-2B.

FIG. 3 is a rear perspective view of a structural member in in the form of a vehicle bumper formed of composite materials and having reinforcement rods.

FIG. 4A is a top perspective view of a portion of a structural member formed in accordance with the various methods of forming structural members in accordance with the embodiments of the present invention.

FIG. 4B is a top perspective view of a structural member formed in accordance with the various methods of forming structural members in accordance with the embodiments of the present invention.

FIG. 5 is an angled side perspective view of a vehicle instrument panel with the structural member located between the A columns.

### DETAILED DESCRIPTION OF THE PREFERRED EMBODIMENTS

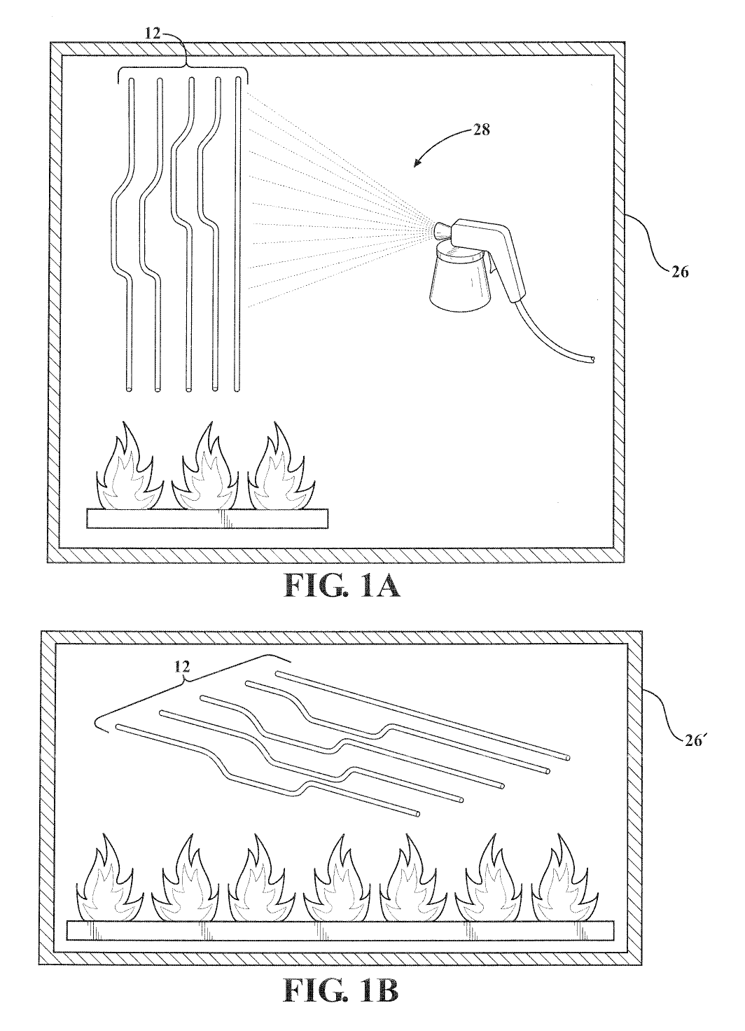

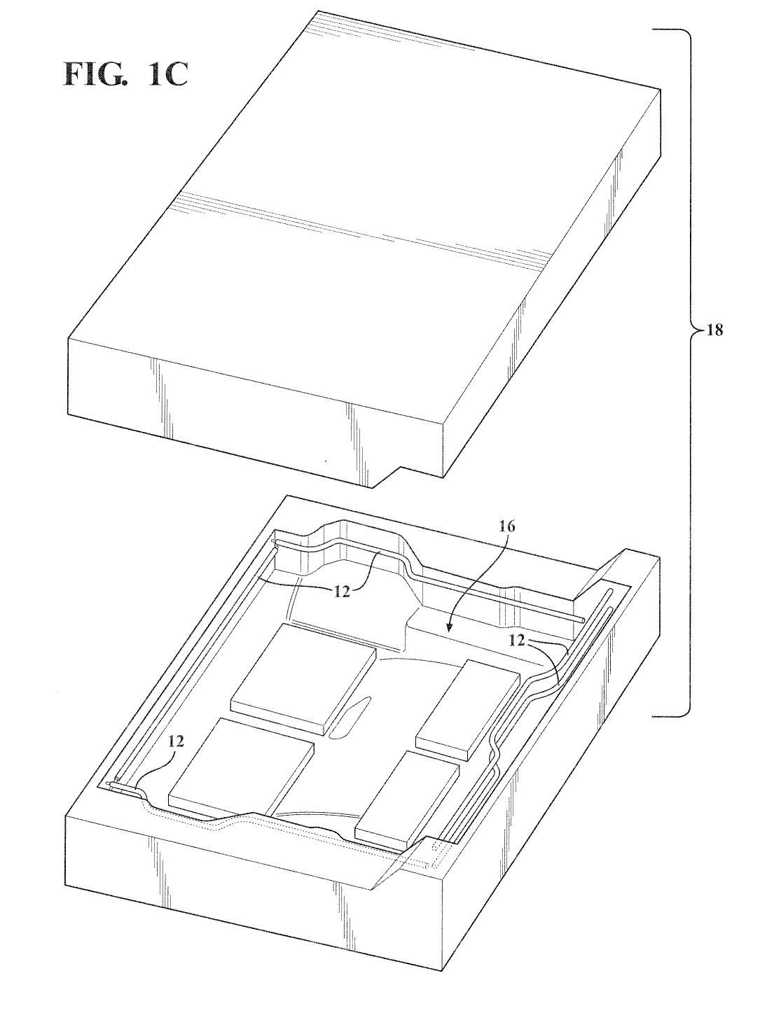

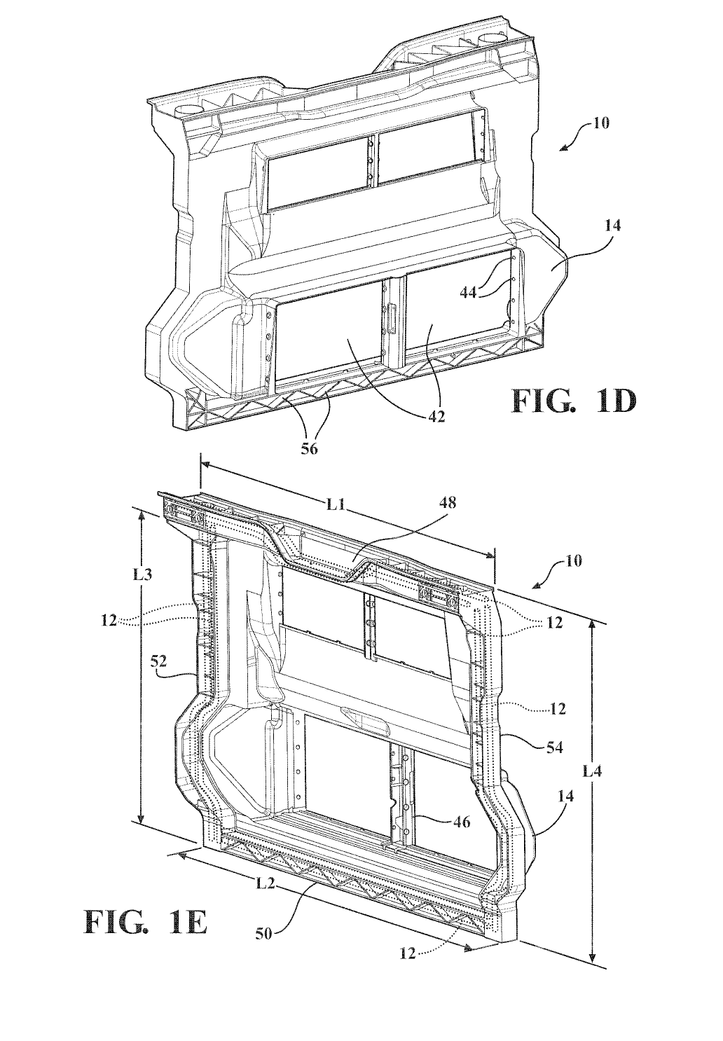

Referring now to FIGS. 1D-1E and FIGS. 2C-2D a structural member 10, 10′ is created using the various methods described below. The structural member 10, 10′ shown is a composite front end carrier module formed during a molding process, described below. The structural member 10, 10′ includes a body 14 that is a one piece composite body formed of a resin material that is a polymer material described in greater detail below. The polymer material optionally includes reinforced fillers such as fiber fillers including carbon fibers, glass fibers, etc. Overmolded to the body 14, 14′ are a plurality of reinforcements 12, 12′ that are pretreated and overmolded to the body 14, 14′ in such way that the pretreatment of the plurality of reinforcements 12, 12′ causes the material of the individual reinforcements to adhere to the resin material forming the body 14, 14′ of the structural member 10, 10′. The body 14, 14′ is one piece and is formed to have one or more openings 42, 42′ that have a plurality of attachment points 44, 44′ for rotatably connecting louvers or vanes (not shown) of an active grille shutter system (not shown) at the perimeter of the one or more openings 42, 42′. There is also an integrally formed active grille shutter system motor housing 46, 46′ that formed as part of the body 14, 14′ and also includes attachment points for connecting a second end of the louvers (not shown), which are then operated using a motor (not shown) installed in the active grille shutter system motor housing 46, 46′.

The body 14, 14′ has a top portion 48, 48′ having a length L1 with at least two of the plurality of reinforcements 12, 12′ extends along a portion of the length L1 of the top portion 48, 48′. A bottom 50, 50′ portion has a length L2 with at least two of the plurality reinforcements 12, 12′ extends along a portion of the length L2 of the bottom portion 50, 50′. A left side portion 52, 52′ having a length L3 with at least two of the plurality reinforcements 12, 12′ extends along a portion of the length L3 of the left side portion 52, 52′, wherein the left side portion 52, 52′ extends between the top portion 48, 48′ and the bottom portion 50, 50′. A right side portion 54, 54′ having a length L4 with at least two of the plurality reinforcements 12, 12′ extends along a portion of the length L4 of the right side portion 54, 54′. The right side portion 54, 54′ extends between the top portion 48, 48′ and the bottom portion 50, 50′. Since the body 14, 14′ is made of a composite material it is further strengthened with a plurality of integrated external reinforcement ribs 56, 56′ that are formed during the molding process.

The methodology of the present invention is used to create other structural members. Additional examples will be discussed, but not limited to the examples shown in FIGS. 3 and 4A-4C, which show a structural member 18, 100. In FIG. 3 the structural member 18 is a composite bumper and in FIGS. 4B and 5 the structural member 100 is a transverse support, the details of which will be discussed in greater detail below.

The structural member 10, 10′ shown is a composite front end module for a motor vehicle. However, it is possible for the structural member to take many forms including, but not limited to, crush cans, transverse support members, lift gates, tailgates, bumpers, etc. or any other structural member that would benefit from the increased strength of the reinforcement rods.

The body of the structural member 14, 14′ is made of resin material, which is preferably castable urethane, polypropylene, polyamide, polyester or nylon resins, which may or may not have filler material such as carbon fibers or glass fibers. The plurality of reinforcements 12, 12′ which are depicted as reinforcement rods that are preferably made of steel, but can also be made of aluminum, iron, metal alloys, polymer, polymer with fiber reinforcements or virtually any material having a suitable tensile strength. While the reinforcements 12, 12′ in this specification are shown and described as rods, it is within the scope of this invention for them to have other shapes or forms such as ribbons, plates, threads, mesh, chain link etc.

Referring to FIGS. 1A-1C schematic diagrams are depicted showing the steps of forming the structural member 10. The structural member 10 formed as an end product of the method includes steel or metal reinforcement rods 12 that are over molded into the resin body 14 of the structural member or finished part. The present invention seeks to improve on and better over mold the metal reinforcements into the resin of the part by providing a method described herein in accordance with the embodiments of the invention.

FIGS. 1A-1C show a schematic of a method of creating the structural member 10, shown in FIGS. 1D-1E, according to a first embodiment of the invention. During a first step shown in FIG. 1A, the metal reinforcement rods 12 are placed in an oven 26 and an adhesive coating 28 is applied to the reinforcement rods 12. The adhesive coating 28 can be applied using a spray, powder coating and then subsequently baking the rods, a dip, brushing the rods with the liquid adhesive or other suitable process for coating the rods with an adhesive. While the process show in FIG. 1A is depicted as being done in an oven 26, it is within the scope of this invention for the adhesive coating to be applied at ambient temperatures without any heating of the rods 12 or adhesive 28.

After the first step of coating the reinforcement rods 12, as depicted in FIG. 1A, the rods 12 with the coating are heated in an oven 26′ as depicted in FIG. 1B, which can be necessary for certain types of adhesives. However, as mentioned above the application of the adhesive can be done at ambient temperatures, and the step of heating the coated rods 12 as shown in FIG. 1B is also not necessary for certain types of applications.

The type of adhesives contemplated being used in accordance with the present invention are generally nylon or polypropylene adhesives. However the specific adhesives can include other types of adhesives. In one aspect of the invention the adhesive used is THIXON™ 422 manufactured by Rohm and Haas Company, which is a one-component, solvent-based adhesive for bonding castable urethane to metal substrates, offering very good high temperature resistance. In another aspect of the invention the specific adhesive used is an adhesion promoter called VESTAMELT® Hylink manufactured by Evonik Resource Efficiency Gmbh, which is a cross linkable copolyamide adhesion promoter (e.g. a compound that makes the resin of the body 14 stick to the individual rods 12) for metal-plastic hybrid components with outstanding resistance to heat and mechanical stress. While THIXON™ 422 and VESTAMELT® Hylink are specifically mentioned it is within the scope of this invention for any suitable adhesive or adhesion promoter to be used provided whatever compound used, makes the resin of the body 14 stick to the individual rods 12.

In embodiments where the rods 12 are coated in an oven or preheated before molding, as shown in FIG. 1A and 1B it is within the scope of this invention for a suitable activation temperature to be greater than about 150° C., about 155° C., about 160° C., about 170° C., about 180° C. or any increments there between about 150° C. and about 180° C. The heating activation step can occur at a later point in time, thus the coating of the reinforcement rod step can be accomplished at a different facility than where the activation step occurs. However immediately after the reinforcement rod is heated to a suitable temperature as described above, the reinforcement rod is immediately placed into a mold cavity 16 of a mold 18.

In embodiments where the coating step is carried out at ambient temperatures and no preheating of the rods is necessary or in embodiments shown in FIG. 1A and 1B, the adhesive used will be activated by the heat of the molten resin, which enters the mold at a temperature of about 200° C. However, in some applications the volume of molten resin might not be great enough to provide enough heat for activation, in such embodiments it is contemplated that additional heating of the mold will occur. Suitable activation temperatures are generally greater than about 90° C., greater than between about 150° C. Depending on the particular adhesive used an activation temperature range between about 90° C. to about 150° C., between about 93° C. to about 104° C., a range between about 95° C. to about 145° C., a range between about 100° C. to about 140° C., a range between about 105° C. to about 135° C., a range between about 110° C. to about 130° C., a range between about 115° C. to about 125° C., a range between about 95° C. to about 120° C., a range between about 95° C. to about 115° C. a range between about 95° C. to about 110° C., a range between about 95° C. to about 105° C., a range between about 95° C. to about 100 C. or any sub-ranges there between is used.

Referring back to FIGS. 1C-1E the body 14 of the structural member 10 is formed within the cavity 16 of the mold 18, thereby overmolding the reinforcement 12 into the body 14 of the structural member 10. The method of forming the structural member 10 includes placing the coated reinforcement rods 12 at designated positions in the mold cavity 16. Next the top portion and bottom portion of the mold 18 are brought together and molten resin is injected into the mold 18, filling the mold cavity 16 with molten resin and thereby overmolding the reinforcement rods 12 into the structural member 10. The resins used in the molding step are poly propylene resins or nylon resins, which may or may not have filler material such as carbon fibers or glass fibers.

Referring now to FIGS. 2A, a second embodiment of the invention is shown having reinforcements 12′ that are coated using a plasma spray method. The plasma spray method coats the reinforcements 12′ with a charged adhesive or adhesion promoter. During a first step a first spray stream 32 from a first spray source 34 is sprayed onto the reinforcements 12′ to clean them with a cleaning solution. The cleaning solution can be any suitable aqueous or organic solution, with specific examples being acetone or silane. The first spray source 34 is a spray nozzle that sprays a liquid solution or mist, or in the alternative depending on the type of cleaning solution used, the first spray source 34 includes a plasma stream.

At a second step a second spray stream 36, which in one embodiment is a silane stream of plasma having an adhesive is sprayed from a second spray source 38 onto the reinforcements 12′. The second spray source 38 is a plasma spray source. The type of adhesive used can be a plasma spray able adhesive similar to the adhesives mentioned above with reference to FIGS. 1A and 1B, or any other suitable adhesive that can be sprayed using a plasma stream.

The process is optionally carried out in an oven 40 having a heat source 42 that heats the reinforcements 12′. However, it is contemplated that certain types of adhesive can be applied using the plasma spray technique with the reinforcements 12′ being kept at ambient temperature. If the plasma spray method requires heat the oven 40 environment is between about 160° C. to about 180° C. or any temperature there between. However, depending on the type of adhesives it is possible that both of the above steps occur at ambient temperatures, with the adhesives having the same curing temperature ranges as described above with respect to FIGS. 1A-1E. While an oven is described above, the oven can take many forms such as an infrared oven or heating element, resistive implant welding unit, laser or any other suitable means of inducing heat to the reinforcement element. The oven can also be just a fan that blows ambient air onto the coated rods to promote drying of the adhesive onto the rods.

Structural members of this kind may be used, for example, as supporting structures in motor vehicles, examples include, but are not limited to crush cans, front end modules and transverse supporting members.

FIG. 2B shows a side cross-sectional view of a closed mold 19 that can be any type of mold with a mold cavity used to make a structural member 27.

The structural member 27 is shown generically and hereby represents any structural member produced according to the methods described herein, including the reinforced composite member 10, 10′ (described above), vehicle bumper 18 (described below), transverse supporting member 100 (described below) or any other type of product made according to the teachings of the method of the invention. As shown there a plurality of reinforcements 13 overmolded within a resin 29 material that forms the body of the structural member 27. The reinforcements 13 are coated with a layer 31 of coating that is an adhesive coating applied in a manner described above with respect to FIGS. 1A, 1B and 2A. The layer 31 of coating causes the resin 29 of a structural part 27 to bond to the reinforcements 13.

Referring now to FIG. 3 a rear view of a structural member, in the form of a vehicle bumper 18. The vehicle bumper 18 has attachment points 20 and a body 22. Attachment points 20 and the body 22 are formed of composite material having reinforcements 24 shown in a phantom extending through the body 22 of the vehicle bumper 18. Additionally reinforcements 24′ similar to reinforcements 24 of the body 22 are overmolded to the attachment points 20.

Referring now to FIGS. 4A-4C and 5, there is depicted a structural member in the form of the transverse supporting member 100. The transverse supporting member 100 includes a body 102 formed from a molded upper portion 104 connected to a molded lower portion 106. As shown in FIG. 4C the lower portion 106, as well as the upper portion 104 include metal reinforcement rods 108 similar to the metal reinforcement rods depicted in the other embodiments of the invention. The metal reinforcement rod 108 are overmolded to the upper portion 104 and lower portion 106 using method similar to those discussed above in FIGS. 1A-1C, 2A-2B. Referring now to FIG. 5, the transverse supporting member 100 is shown in phantom from the viewpoint of a vehicle interior 109. The transverse supporting member 100 is located behind an instrument panel 112 and is used to procure a connection between the A columns 110. The transverse supporting member 100 allows for the air conditioner, the steering wheel-side steering column bearing, the airbag and other subassemblies to be connected thereon. For this purpose, the transverse supporting member 100 must have high rigidity, so as to be able to resist the forces introduced from the steering column connection through the steering wheel.

The description of the invention is merely exemplary in nature and, thus, variations that do not depart from the gist of the invention are intended to be within the scope of the invention. Such variations are not to be regarded as a departure from the spirit and scope of the invention.

1. A method of making a structural member comprising the steps of:
providing one or more reinforcements, one or more adhesives, a mold with a mold cavity and resin;
coating the one or more reinforcements with the one or more adhesives;
placing the one or more reinforcements coated with one or more adhesives into the mold cavity;
overmolding the one or more reinforcements by injecting molten resin into the mold cavity and then curing the molten resin to form the structural member; and
pre-heating the one or more reinforcements coated with the one or more adhesives to activate the one or more adhesives prior to the step of overmolding or prior to the step of placing the one or more reinforcements into the mold cavity.

2. (canceled)

3. The method of claim 1 wherein the pre-heating of the one or more reinforcements is carried out at a temperature greater than about 150° C.

4. The method of claim 1 wherein the pre-heating of the one or more reinforcements is carried out at a temperature range between about 150° C. to about 180° C.

5. The method of claim 1 wherein the coating step further includes plasma spraying the adhesive onto the one or more reinforcements using a first spray having a cleaning solution and then a plasma spray containing a stream of plasma containing the one or more adhesives.

6. The method of claim 1 wherein the step of coating the one or more reinforcements with one or more adhesives occurs at ambient temperature.

7. The method of claim 6 further comprising the curing of the molten resin by heating the mold cavity, wherein the one or more adhesives are activated by heat in the mold cavity during the step of overmolding.

8. The method of claim 7 wherein the one or more adhesives are activated at a temperature range between about 90° C. to about 150° C.

9. The method of claim 7 wherein the one or more adhesives are activated at a temperature range between about 115° C. to about 125° C.

10. A method of making structural member comprising the steps of:
providing one or more reinforcements made of steel wire;
providing one or more adhesives being at least one selected from the group consisting essentially of a nylon adhesive and a polypropylene adhesive;
providing a mold having a mold cavity;
providing a resin material being at least one selected from the group consisting essentially of polypropylene a resin and a nylon resin;
coating the one or more reinforcements with the one or more adhesives;
placing the one or more reinforcements coated with one or more adhesives into the mold cavity;
overmolding the one or more reinforcements by injecting molten resin into the mold cavity and then curing the molten resin.

11. The method of claim 10 further comprising the step of pre-heating the one or more reinforcements coated with the one or more adhesives to activate the one or more adhesives prior to the step of overmolding or prior to the step of placing the one or more reinforcements into the mold cavity.

12. The method of claim 11 wherein the pre-heating of the one or more reinforcement rods is carried out at a temperature greater than about 150° C.

13. The method of claim 14 wherein the pre-heating of the one or more reinforcement rods is carried out at a temperature range between about 150° C. to about 180° C.

14. The method of claim 10 wherein the step of coating the one or more reinforcements with one or more adhesives occurs at ambient temperature.

15. The method of claim 14 further comprising the curing of the molten resin by heating the mold cavity, wherein the one or more adhesives are activated by heat in the mold cavity during overmolding.

16. The method of claim 15 wherein the one or more adhesives are activated at a temperature range between about 90° C. to about 150° C.

17. The method of claim 15 wherein the one or more adhesives are activated at a temperature range between about 115° C. to about 125° C.

18. The method of claim 10 wherein the coating step further includes plasma spraying the adhesive onto the one or more reinforcements using a first spray of a cleaning solution and then a plasma spray containing a stream of plasma containing the one or more adhesives.

19. (canceled)

20. (canceled)

21. (canceled)

22. (canceled)

23. The method of claim 1 wherein the resin is one or more selected from the group consisting essentially of castable urethane resins, polypropylene, polyester, polyamide and nylon.

24. The method of claim 23 wherein the resin further includes a fiber filler than is carbon fibers, glass fibers or a combination thereof.

25. (canceled)
